(19) United States
(12) Patent Application Publication
(10) Pub. No.: US 2021/0357484 A1
(43) Pub. Date: Nov. 18, 2021

(54) AUTHENTICATION IN VIRTUAL ENVIRONMENTS

(71) Applicant: Hewlett-Packard Development Company, L.P., Spring, TX (US)

(72) Inventors: Donald Gonzalez, Palo Alto, CA (US); Andrew Hunter, Bristol (GB); Stuart Lees, Bristol (GB)

(73) Assignee: Hewlett-Packard Development Company, L.P., Spring, TX (US)

(21) Appl. No.: 17/043,076

(22) PCT Filed: Aug. 13, 2018
(86) PCT No.: PCT/US2018/046524

§ 371 Date: Sep. 29, 2020

(51) Int. Cl. G06F 21/32; G06F 21/84; G06T 19/00

(52) U.S. Cl. CPC G06F 21/32; G06T 19/006; G06F 21/84

(57) ABSTRACT

Example implementations relate to authentication invirtual reality systems. For example, a device comprising a generator engine can generate a stimulus, and display the stimulus to the user in a virtual environment. The device can receive an input from the user in response to the stimulus, via a receiver engine, and authenticate the user based on the input received via an authentication engine. Additionally, the device can obfuscate the received input from the user by preventing the input from being displayed in the virtual environment via an obfuscation engine.

### BACKGROUND

Virtual reality (VR) and/or augmented reality (AR) systems may be used to provide an altered reality to a user. VR and AR systems may include displays to provide a “virtual and/or augmented” reality experience to the user by providing video, images, and/or other visual stimuli to the user via the displays. A VR system may be worn by a user.

### BRIEF DESCRIPTION OF THE DRAWINGS

FIG. 1 illustrates an example device for user authentication consistent with the disclosure.

FIG. 2 illustrates an example device for user authentication consistent with the disclosure.

FIG. 3 illustrates an example of a system including a virtual reality device consistent with the disclosure.

FIG. 4 illustrates an example of a virtual environment with a plurality of stimuli consistent with the disclosure

### DETAILED DESCRIPTION

VR systems can include head mounted devices. As used herein, the term “VR ” system refers to a device that creates a simulated environment for a user by placing the user visually inside an experience. Contrary to an AR device and/or system, a VR system user can be immersed in, and can interact with, three dimensional (3D) worlds. As defined herein, the term “AR device” refers to a device that simulates artificial objects in the real environment. In augmented reality, users can see and interact with the real world while digital content is added to it.

In some examples, a VR system can use VR headsets or multi-projected environments, sometimes in combination with physical environments or props, to generate realistic images, sounds and other sensations that simulate a user's physical presence in a virtual or imaginary environment. As used herein, the term “environment” refers to a space in which the VR system, and/or the AR system visually locates a user and can include an aggregate of surrounding things, conditions, and/or influences in the space. For example, the environment may be a virtual room in a building having furniture, electronics, lighting, etc., and may include doors and/or windows through which other people or animals (e.g., pets) may enter/exit. In some examples, the environment may include an overlay of a transparent or semi-transparent screen in front of a user's eyes such that reality is augmented with additional information such as graphical representations and/or supplemental data.

Due to the immersive capabilities of VR systems, a user may not be aware of the surrounding things (e.g., furniture, electronic devices, etc.), people, and/or animals that may enter and/or traverse the space. Thus, an adversary (e.g., another user) can be in the same physical and/or virtual world as the user, having access to the user's confidential personal resources without the user being aware.

Some previous approaches may use authentication methods that display the authentication process to an adversary in the virtual environment with the user authenticating his or her identity. Such approaches may expose the user's response to specific images and/or stimuli to an adversary, making the authentication process vulnerable.

Accordingly, the disclosure is directed to a device and system to authenticate a user in a virtual and/or augmented reality environment using a user's input based on the user's response to a plurality of stimuli. The system can generate and display a stimulus using a generator engine, and can receive an input from the user in response to the stimulus via a receiver engine. The system can authenticate, via an authentication engine, the user based on the input received in response to the stimulus. As described herein, the term “authentication” refers to identifying, and/or confirming an identity of a user. Additionally, the system can obfuscate the received input, and prevent users other than the user, from seeing the received input.

In some examples, a user in a VR environment can be identified by the user's pattern of behavior that is unique to the user. This pattern of behavior can include responses to regular elements within a VR environment. As described herein, the term “stimulus” refers to a motion (e.g., an unpredictable motion) of an object and/or image in the virtual environment

In some examples, a stimulus can be uniquely visible to a user being authenticated. In some examples, a stimulus can be a naturally added element to the display of a VR system. That is, a naturally added element can be an element that appears to fit into a VR environment, such as a soccer ball on a soccer field or a tree in a forest, in contrast to an element that may not be natural such as a triangle in a cloud or a square on another user's forehead. In such examples, the user's response to the stimulus may be uncontrived. In some examples, the stimulus can be a visual stimulus that overlays, and/or replaces the virtual environment. In some examples, the stimulus may be visible to the user being authenticated and may not be visible to additional users, such as those users not being authenticated. In some examples, the VR system can obfuscate (e.g., hide, and/or falsify) the response received from the user to prevent adversaries of the user from having access to the user's environment. In some examples, the response received from the user can be a realistic representation of the user's behavioral pattern in the virtual environment, as described herein. When the behavioral pattern is displayed, users other than the user can eavesdrop and replicate the user's behavioral pattern to access the user's virtual environment without authorization from the user. By obfuscating the response received from the user, the possible eavesdropping and/or replicating of the user's behavioral pattern can be prevented.

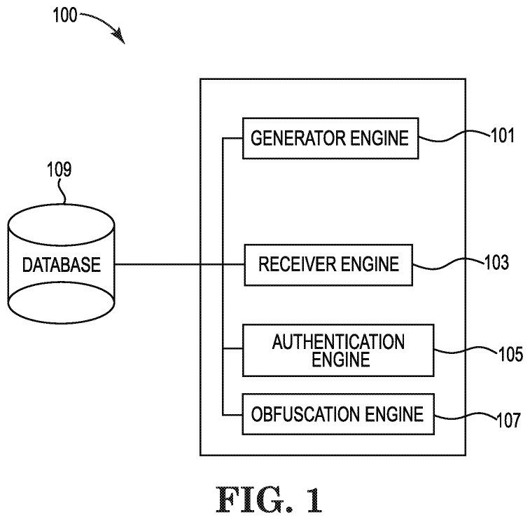

FIG. 1 illustrates an example device 100 for user authentication consistent with the disclosure. Device 100 can include a generator engine 101, a receiver engine 103, an authentication engine 105, and an obfuscation engine 107. As described herein, the term “obfuscation” can refer to falsification of a user's behavior expressed through an avatar in the virtual environment that would otherwise be indicative of the user exhibiting or controlling the behavior but, when falsified through obfuscation, is indicative of behavior not exhibited or controlled by the user. In some examples, generator engine 101 can generate a stimulus. The generator engine 101 can display the stimulus to the user. In some examples, a receiver engine 103 can receive an input from the user in response to the stimulus received from the generator engine 101.

In some examples, a receiver engine 103 can receive an input from the user in response to the stimulus received from the generator engine 101. In some examples, an authentication engine 105 can authenticate the user based on the input received from receiver engine 103 in response to the stimulus. In some examples, the obfuscation engine 107 can obfuscate the received input from the user by preventing the input from being displayed to users other than the user in the virtual environment.

As described herein, the term “generator engine” refers to hardware and/or a combination of hardware and machine-readable instructions, but at least hardware, to cause device 100 to generate a stimulus for display to a user and display the stimulus to the user.

In some examples, the generator engine 101 can generate the stimulus based on the identity of the user. In some examples, the generator engine 101 can generate the stimulus based on the identity of a group of people (e.g., identify a user as a member of an employee group).

In some examples, generator engine 101 can generate the stimulus by identifying the user based on the user's facial features. In some examples, the user can be identified based on the virtual environment the user is in. In some examples, the user can be identified based on the time of the day and/or week the user is in the virtual environment. In some examples, the user can be identified based on the user's initial response to elements of the environment. For example, identifying a red door the user identified previously. The generator engine 101 can display the stimulus via a display. In some examples, the identity of the user can be a data value and/or structure that can be strongly associated with an individual. In some examples, the identity of the user can be based on a set of previously identified users.

The receiver engine 103 can include hardware and/or a combination of hardware and machine-readable instructions, but at least hardware, to receive an input from a sensor. The sensor (not illustrated in FIG. 1) can receive an input from the user as the user responds to the stimulus based on the stimulus generated by the generator engine 101 of device 100. The sensor can be a camera, a proximity sensor, an infrared sensor, a sonar sensor, a touch switch, and/or other sensors that can receive electrical, audio, and/or optical signals.

The receiver engine 103 can receive an input from the user in response to the stimulus displayed to the user via generator engine 101. In some examples, based on the input received by receiver engine 103, a user can be authenticated via authentication engine 105. For example, the receiver engine 103 can receive an input, for instance, a blink pattern, from the user. In response to the received blink pattern the authentication engine 105 can validate the blink pattern information and grant permission to the user to access the environment of the device 100. In some examples, the authentication engine 105 can deny permission to the user to access an environment of the device 100 in response to rendering the blink pattern invalid. In some examples, the input received by receiver engine 103 can include the user's behavioral pattern in response to the stimulus.

As described herein the term “behavioral pattern” refers to a physical behavior of the user, or a virtual behavior of an avatar of the user in the virtual environment that is controlled by the user. In some examples, behavioral pattern can be used to authenticate the user. In some examples, behavioral pattern may not be relied upon by other users to recognise the user. For example, a behavioral pattern can include one of a change in eye movement pattern, widening and narrowing of the eyelids, blink patterns, iris appearance and/or changes in iris appearance, pupil dilation, breathing pattern, head movement, hand movement, walking pattern, electro-dermal changes of the skin, electromyographic changes of the skin, visual skin changes and/or any combination thereof. In some examples, eye movement pattern can include saccades, vestibule-ocular movements, and smooth pursuit eye movements. Such behavioral patterns can be demonstrated in the virtual environment, e.g., the user demonstrating a walking pattern through the virtual environment, etc.

In some examples, input received by the receiver engine 103 can include a behavioral pattern. In such an example, the receiver engine 103 can receive an input (e.g., breathing pattern, blink patterns, etc.) that correspond to a natural behavioral response of the user to a given stimulus. For example, the generator engine 101 can generate a stimulus for display to a user by predicting the user to be a first user for the virtual environment. The assumption can be made based on the time of the day the user uses the device 100, the environment of device 100 the user attempts to enter, and/or other general characteristics. Based on the assumed identity of the first user, the generator engine 101 can display a view similar to an environment the first user has been previously presented with. For example, the environment can be a box with randomized arrangement of symbols, such as one triangle, two rectangles, three hexagons, and four circles, Based on the user's eye widening and narrowing of the eyelids on each symbol, the authentication engine 105 can validate the user to be the first user and grant access to the user to the virtual environment.

In some examples, the stimulus displayed can be a similar view and/or elements from a previously presented virtual environment. For example, a similar view can include a view of a VR environment previously experienced by the user to be authenticated. In some examples, a stimulus can include displaying an altered view that replaces the user's initial view in the virtual environment.

In some examples, the altered view can be a view relative to the user's view prior to the user receiving a stimulus generated by generator engine 101. In some examples, the altered view can be a view altered from a previous view. For instance, stimulus generated by generator engine 101 can be randomized arrangements of elements the user is familiar with and elements the user is unfamiliar with. Based on the user's breathing pattern in response to the known elements, the authentication engine 105 can authenticate the user. For example, if the user is presented with an environment in which the user previously won a virtual game, the user can start breathing faster due to excitement. Based on the user's change in breathing pattering, the authentication engine 105 can validate the user to grant access to the user in the virtual environment. In contrast, if the user's breathing pattern remains unchanged in response to an element the user typically reacts to, the authentication engine 105 can deny access to the user in the virtual environment.

In some examples, the user can be authenticated based on behavioral patterns such as pupil dilation, breathing pattern, walking pattern, head movement, hand movement, or any combination thereof. For example, a user can be authenticated based on his/her head movement to known elements from previously presented elements in the virtual environment. For instance, authentication engine 105 can authenticate a previously authenticated user by analyzing the user's head movement toward known elements. For example, the user may be moving his head prior to coming across anticipated tree branches that the user knows are located along the path the user may be walking on. In some examples, the user can disregard unknown elements. For example, the user may not walk around a hidden trap as the user may not know, from the user's previous experience, the trap's location.

In some examples, the user can be previously authenticated. A previously authenticated user refers to a user who has gone through the process of being recognized via identifying credentials. For example, device 100 can receive an input including facial features of a detected user and compare the detected facial features with facial features included in database 109. Based on the comparison, the device 100 can determine the identity of the user. In some examples, authentication of the user can be a continuous process. For example, the user can be tracked continuously by authenticating the user based on one or more threshold levels (e.g., password, facial feature, previously authenticated behavioral pattern) to maintain confidence that the authentication remains valid.

In some examples, the user of device 100 can view a First Person View (FPV) in the virtual environment. As described herein, the term “FPV” refers to the user's ability to see from a particular visual perspective other than the user's actual location (e.g., the environment of a character in a video game, a drone, or a telemedicine client, etc.). In some examples, the user viewing an FPV in the virtual environment can examine remote patients and control surgical robots as the user can see from the perspective of the patient's location.

Obfuscation engine 107 of device 100 can obfuscate the received input from the user. As described herein, the term “obfuscation engine” refers to hardware and/or a combination of hardware and machine-readable instructions, but at least hardware, to cause device 100 to obfuscate the received input from the user by preventing the input from being displayed in the virtual environment. In some examples, the obfuscation engine 107 can deliberately create code to hide the input received from receiver engine 103 to prevent adversaries from unauthorized access to the user's virtual environment. In some examples, obfuscation engine 107 can substitute information and display non-related information to hide the input received from the receiver engine 103. In some examples, obfuscation engine 107 can hide physical response received from the user via receiver engine 103 by not displaying them in the virtual environment. In some examples, obfuscation engine 107 can create user specific codes that adversaries cannot decode in the virtual environment. The device 100 can include additional or fewer engines that are illustrated to perform the various elements as described in connection with FIG. 1.

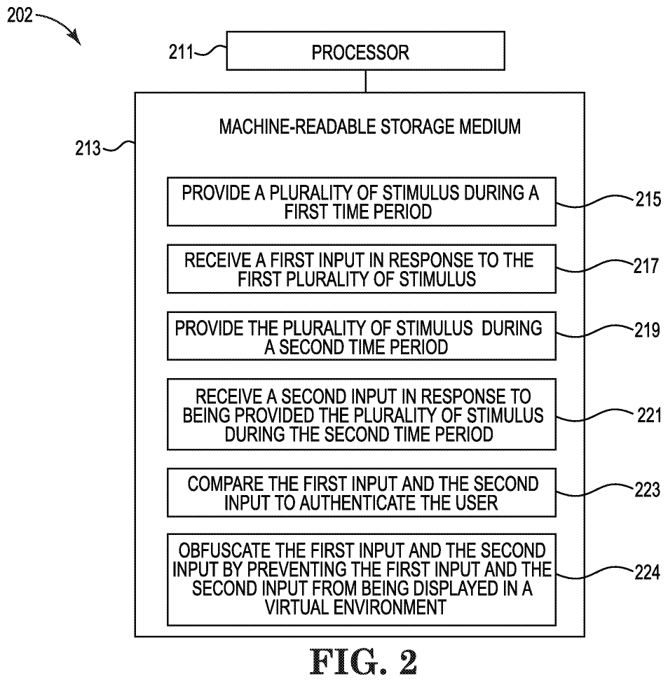

FIG. 2 illustrates an example device 202 for user authentication consistent with the disclosure. In the particular example shown in FIG. 2, device 202 includes a processor 211 and a machine-readable storage medium 213. The machine-readable storage medium 213 can be a non-transitory machine-readable storage medium. Machine-readable storage medium 213 can include instructions 215, 217, 219 221, 223 and 224 that, when executed via processor 211, can execute first provide, first receive, second provide, second receive, compare instructions, and obfuscate input. Although the following descriptions refer to an individual processor and an individual machine-readable storage medium, the descriptions can also apply to a system with multiple processing resources and multiple machine-readable storage mediums. In such examples, the instructions can be distributed across multiple machine-readable storage mediums and the instructions can be distributed across multiple processing resources. Put another way, the instructions can be stored across multiple machine-readable storage mediums and executed across multiple processing resources, such as in a distributed computing environment.

Processor 211 can be a central processing unit (CPU), microprocessor, and/or other hardware device suitable for retrieval and execution of instructions stored in machine-readable storage medium 213. In the particular example shown in FIG. 2, processor 211 can execute first provide 215, first receive 217, second provide 219, second receive 221, and compare 223 instructions. As an alternative or in addition to receiving and comparing instructions, processor 211 can include an electronic circuit comprising a number of electronic components for performing the operations of the instructions in machine-readable storage medium 213. With respect to the executable instruction representations or boxes described and shown herein, it should be understood that part or all of the executable instructions and/or electronic circuits included within one box can be included in a different box shown in the figures or in a different box not shown.

Machine-readable storage medium 213 may be any electronic, magnetic, optical, or other physical storage device that stores executable instructions. Thus, machine readable storage medium 213 may be, for example, Random Access Memory (RAM), an Electrically-Erasable Programmable Read-Only Memory (EEPROM), a storage drive, an optical disc, and the like. The executable instructions may be “installed” on device 202 illustrated in FIG. 2. Machine-readable storage medium 213 may be a portable, external or remote storage medium, for example, that allows the device 202 to download the instructions from the portable/external/remote storage medium. In this situation, the executable instructions may be part of an “installation package”. As described herein, machine-readable storage medium 213 may be encoded with executable instructions related to alerts of virtual reality devices. That is, using processor 211, machine-readable storage medium 213 can cause a device to receive a first input from user during a first time period, receive a second input from the user during a second time period, and compare the first input and the second input to authenticate the user, among other operations.

Device 202 can include instructions 215. Instruction 215, when executed by the processor 211, can provide a plurality of stimuli to a user during a first time period. In some examples, the first time period can be the first time the user enters a virtual environment.

In some examples, a plurality of stimuli can be elements from a previously presented virtual environment. For example, in a virtual golf game environment, the user (e.g., a golfer) can be provided with a plurality of stimuli (e.g., favorite golf course, favorite clubs) that the user has been presented with previously. In some examples, a plurality of stimuli can be altered elements replacing the same user's view, for example unfamiliar golf course, in the previously presented virtual environment.

Device 202 can include instruction 217. Instruction 217, when executed by the processor 211, can receive a first input from the user in response to the first plurality of stimuli. In some examples, the first input can include behavioral patterns such as, pupil dilation, breathing pattern, head movement, hand movement, and/or any combination thereof. For example, instruction 217, when executed by processor 211, can cause device 202 to receive a first input. In some examples, the first input can be asking the user, (e.g., the golfer mentioned while discussing instruction 215 above) to walk to the third hole, in response to the user ecognizing the user's favorite golf course in the virtual environment,

Device 202 can include instruction 219. Instruction 219, when executed by the processor 211, can provide the plurality of stimuli to the user during a second time period. In some examples, the second time period can be a subsequent time period from the first time period the user enters the virtual environment,

Device 202 can include instruction 221. Instruction 221, when executed by the processor 211, can receive a second input from the user in response to being provided the plurality of stimuli during the second time period. In some examples, the second input can include behavioral patterns such as, pupil dilation, breathing pattern, head movement, hand movement, and/or any combination thereof. For example, the user (e.g., golfer mentioned while discussing instruction 215 above), can receive his/her favorite golf clubs as plurality of stimulus during a second time period. In response to the user receiving his/her favorite golf clubs, the device 202 can receive a second input. For example, golfer may play a certain golf player using in response to receiving his/her favorite golf clubs during the second time period.

Device 202 can include instruction 223. Instruction 223, when executed by the processor 211, can compare the first input and the second input to authenticate the user. In some examples, an authentication engine (e,g., authentication engine 105 in FIG. 1) can confirm authentication of the user in response to the comparison of the first input and the second input being greater than a threshold similarity. For example, device 202 can include a database with threshold data from the user. In some examples, device 202 can receive a first input, for example blink patterns, during a first time point as the user receives an image of a townscape of the user's favorite vacation destination. The device 202 can receive a second input change in user's blink patterns, during a second time point. In some examples, device 202 can compare the first input and the second input to authenticate the user by comparing the first input and the second input being greater than a threshold similarity.

Device 202 can include instruction 224, Instruction 224, when executed by the processor 211, can obfuscate the first input and the second input from the user by preventing the first input and the second input from being displayed in a virtual environment.

As described herein, the term “threshold similarity” refers to a lower limit for the similarity of two data records that belong to the same cluster. For example, if threshold similarity in device 202 is set at 0.25, the comparison value of the first input data and the second input data greater than 25% can be authenticated by executing instructions 223. In some examples, device 202 can reject authentication of the user in response to the comparison of the first input and the second input being less than a threshold similarity. For instance, if a threshold similarity in device 202 is set at 0.25, the comparison value of the first input data and the second input data less than 25% device 202 can reject authentication of the user at instructions 223 for having an input being less than a threshold similarity level.

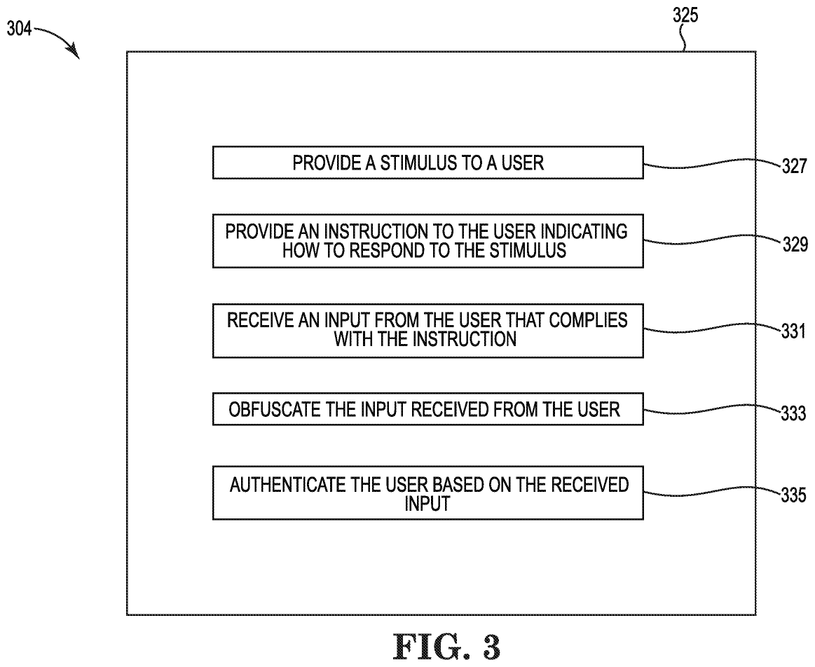

FIG. 3 illustrates an example of a system 304 including a VR device 325 consistent with the disclosure. Virtual reality device 325 can cause system 304 to execute instructions 327, 329, 331, 333 and 335 to provide, receive, obfuscate and authenticate in a virtual reality environment.

VR device 325 can be an interactive computer-generated experience taking place within a simulated environment, that can incorporate auditory, visual and/or types of sensory feedback. In some examples, a sensor (not illustrated in FIG. 3) can be included in the VR device 325. In some examples, a sensor can be remotely located from the VR device 325.

In some examples, the VR device 325 can include a controller. Although not illustrated in FIG. 3 for clarity, and so as not to obscure examples of the disclosure, the controller can be included in VR device 325. However, examples of the disclosure are not so limited. For example, the controller can be located remotely from VR device 325. In such an example in which the controller is located remotely from VR device 325 , the controller can receive the input from a network relationship. The network relationship can be a wired network relationship or a wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, a Bluetooth network relationship, and/or the Internet, among other types of network relationships.

Although not illustrated in FIG. 3 for clarity, and so as not to obscure examples of the disclosure, the controller of VR device 325 can include a processor and a machine readable storage medium, similar to processor 211 and machine readable storage medium 213 illustrated in FIG. 2.

System 304 can include instructions 327. VR device 325 can provide a stimulus to a user by executing instruction 327. In some examples, VR device 325 can provide a stimulus, for example, pictures of soccer teams.

System 304 can include instructions 329. By executing instructions 329, VR device 325 provide an instruction to the user indicating how to respond to the stimulus. In some examples, by executing instruction 329 the VR device 325 can provide an instruction to the user to indicate the user's favorite soccer teams.

System 304 can include instructions 331. By executing instructions 331, VR device 325 can receive an input from the user that indicates a physical response from the user and complies with the instruction by executing instruction 329. As described herein, the term “physical response” refers to the automatic and instinctive physiological responses triggered by a stimulation. In some examples, physical response eye movement pattern, widening and narrowing of the eyelids, blink patterns, pupil dilation, breathing pattern, head movement, and hand movement, or any combination thereof. In the example above, system 304 can receive input from the user that indicates change in the user's breathing pattern as the user responds to the image of the soccer team that the user lost against previously.

System 304 can include instructions 333. VR device 325 can execute instructions 333 to obfuscate the physical response of the user by preventing the physical response from being shown in a virtual environment and showing a different physical response of the user by executing instruction 333. In some examples, obfuscating the input comprises hiding the physical response displayed to users other than the user in the virtual environment. For instance, system 304, by executing instruction 333, can obfuscate the blinking pattern of the user from users other than the user to prevent unauthorized access to the user's virtual environment.

In some examples, VR device 325 can display a different physical response than the physical response of the user. For example, the different physical response can be walking a different path from what the user is instructed to do. In some examples, the user can receive instructions to do certain hand gestures in response to recognizing known elements, and pin certain images. For example, the user can be asked to attach a pin, or pins in a specified position in response to recognizing known elements. The user's hand gestures can be obfuscated from the others in the virtual environment and pinning the images in a different order from instructed to the user can be displayed on the display of the VR device 325.

System 304 can include instructions 335. VR device 325 authenticate the user based on the received input by executing instruction 335. In some examples, in response to receiving a physical response that matches the response of a previously recorded response, system 304 can authenticate the user. In some examples, the previously recorded response can be a response recorded at a time period prior to a real time. In some examples, the previously recorded response can be a baseline data received from a database.

In some examples, if authentication is unsuccessful, an alert can be generated in response to detecting users other than the user in the virtual environment. In some examples, the alert can be a haptic feedback. In some examples, the alert can be an audio alert.

In some examples, one or more further actions are performed by system 304 to control access to the VR environment, via device 325, in response to authenticating and/or failing to authenticate the user.

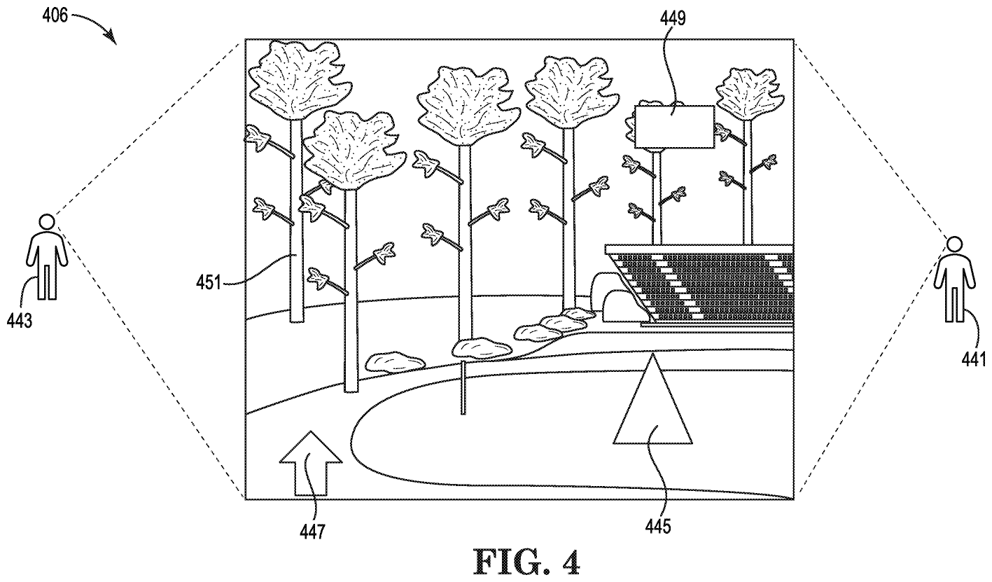

FIG. 4 illustrates an example of a virtual environment 406 including a plurality of stimuli consistent with the disclosure. The virtual environment 406 includes a virtual golf course. Virtual environment 406 can be accessed by user 441 and user 443. In some examples, user 441 can be identified as the user, and user 443 can be identified as the user other than the user, as described herein. Element 451 can be an element existing in the virtual environment 406. Elements 445, 447, and 449 can be stimulus in the virtual environment 406 provided by a system, similar to system 330, as illustrated in FIG. 3.

In some examples, a VR device, similar to the VR device 325, as illustrated in FIG. 3, can provide the user with stimuli 445, 447 and 449. The VR device can provide the user 441 instructions indicating how to respond to 445, 447 and 449. For example, user 441 can be instructed to look at the triangular stimulus 445 first, followed by the rectangular stimulus 449 and blink twice at the stimulus 449. The user can then be instructed to walk on the arrowed element 447 to reach the tree element 451. In some examples, the user 443 can be in the same environment 406, viewing the same stimuli 445, 447, 449 and 451. In some examples, the physical response of user 441 (for example, blinking twice at element 449, and walking on path 447 to reach 451) can be obfuscated from user 443 by preventing the physical response from being shown to user 443. In some examples, a different physical response than the physical response of user 441 can be displayed to the user 443. For example, user 443 can view the user 441 walking the opposite direction of stimulus 451.

In some examples, user 441 can be authenticated based on the input 441 provided in response to the received instruction. In some examples, in response to user 441 complying with the instructions provided, the user can be authenticated and have full access to environment 406.

As used herein, “a”, “an”, or “a number of” something can refer to one or more such things, while “a plurality of” something can refer to more than one such thing. For example, “an aperture” can refer to one or more apertures, while a “plurality of pockets” can refer to more than one pocket.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

What is claimed is:

1. A device comprising:
a generator engine to:
generate a stimulus for display to a user in a virtual environment; and
display the stimulus to the user in the virtual environment;
a receiver engine to receive an input from the user in response to the stimulus;
an authentication engine to authenticate the user based on the input received in response to the stimulus; and
an obfuscation engine to obfuscate the received input from the user by preventing the input from being displayed in the virtual environment

2. The device of claim 1, wherein the input to authenticate the user includes user's behavioral pattern in response to the stimulus.

3. The device of claim 2_{;} wherein the behavioral pattern includes one of change in eye movement pattern_{;} widening and narrowing of the eyelids, blink patterns_{;} pupil dilation, changes in iris appearance, breathing pattern, head movement, hand movement, electro-dermal skin changes, electromyographic skin changes, and visual skin changes_{;} or any combination thereof.

4. The device of claim 1, wherein displaying the stimulus comprises displaying one of:
a similar view from a previously presented virtual environment;
an altered view replacing the user's view in the virtual environment; or
a combination thereof.

5. The device of claim 1, wherein the user is a returning user previously authenticated.

6. The device of claim 1, wherein the obfuscation engine is to obfuscate the received input during particular periods of time while the user is being authenticated.

7. A device, comprising:
a processor; and
a memory resource storing machine readable instructions executable by the processor to:
provide a plurality of stimuli to a user during a first time period;
receive a first input from the user in response to the first plurality of stimuli;
provide the plurality of stimuli to the user during a second time period;
receive a second input from the user in response to being provided the plurality of stimuli during the second time period;
compare the first input and the second input to authenticate the user; and
obfuscate the first input and the second input from the user by preventing the first input and the second input from being displayed in a virtual environment.

8. The device of claim 7, wherein the processor executes the machine readable instructions to confirm authentication of the user in response to the comparison of the first input and the second input being greater than a threshold similarity.

9. The device of claim 7, wherein the processor executes the machine readable instructions to reject authentication of the user in response to the comparison of the first input and the second input being less than a threshold similarity.

10. The device of claim 7, wherein the first input comprises a first behavioral pattern and the second input comprises a second behavioral pattern.

11. A system comprising:
a virtual reality (VR) device to:
provide a stimulus to a user;
provide an instruction to the user indicating how to respond to the stimulus;
receive an input from the user that indicates a physical response from the user and complies with the instruction;
obfuscate the physical response of the user by preventing the physical response from being shown in a virtual environment; and
authenticate the user based on the received input.

12. The system of claim 11, wherein obfuscating the physical response includes changing the instructions to users other than the user,

13. The system of claim 11, wherein preventing the physical response from being shown in the virtual environment comprises displaying a different physical response than the physical response of the user.

14. The system of claim 11, wherein the different physical response is displayed to users other than the user in the virtual environment.

15. The system of claim 11, wherein an alert is generated in response to detecting users other than the user.
